(19) United States
(12) Patent Application Publication
(10) Pub. No.: US 2009/0277965 A1
(43) Pub. Date: Nov. 12, 2009

(54) SEMICONDUCTOR MEMORY CARD

(75) Inventors: Masayuki Toyama, Osaka (JP); Masahiro Nakanishi, Kyoto (JP); Hirofumi Nakagaki, Osaka (JP); Tomoaki Izumi, Osaka (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/089,825

(22) PCT Filed: Oct. 10, 2006
(86) PCT No.: PCT/JP2006/320189

§ 371 Date: Jul. 9, 2008

(30) Foreign Application Priority Data
Oct. 28, 2005 (JP) 2005-314187

(51) Int. Cl. G06K 19/07

(52) U.S. Cl. 235/492

(57) ABSTRACT

A semiconductor memory card is provided with a transmitting and receiving circuit of a plurality of transmission systems such as a single-end signaling transmitting and receiving unit and a differential signaling transmitting and receiving unit. When power is turned on, each transmitting and receiving unit is turned on. When a command is provided from a host device, a command processing unit judges the transmission system provided in the host device, based on reception results of each circuit. Then, only a transmitting and receiving unit of the system identical to the transmission system used for transmission is turned on, and the subsequent data transmission is performed. Thus, the semiconductor memory card provided with a plurality of transmission systems performs transmission by simply identifying the transmission system provided in the host device.

### TECHNICAL FIELD

The present invention relates to a semiconductor memory card which connects to a host device via a plurality of signal lines and is detachable with respect to the host device.

### BACKGROUND ART

As a memory device for storing digital information in devices handling digital information (hereinafter referred to as a host device) such as a personal computer, a movie, a mobile phone, a portable music player, there is a semiconductor memory card having a nonvolatile memory. The semiconductor memory card and the host device connect each other via a plurality of signal lines. A transmission system for the signal lines connecting the semiconductor memory card with the host device includes a single-end signaling system and a differential signaling system. Patent document 1 discloses an IC card where a plurality of transmission circuits share terminals and which uses the transmission systems are changed in accordance with setting by the host device in order to accommodate a plurality of the transmission systems.

Patent document 1: Japanese Unexamined Patent Publication No. 2002-183691

### DISCLOSURE OF INVENTION

### Problem to be Solved by the Invention

Since a semiconductor memory card such as an IC card is generally detachable from a host device, the semiconductor memory has to confirm what type of transmission system is employed in connecting to the host device each other and a transmission system of the semiconductor memory card or the IC card has to be changed depending on the transmission system employed by the host device.

The IC card disclosed in Patent document 1, however, is not able to judge the transmission system employed by the host device and to change a transmission system. The host device has to configure the IC card in order to change the transmission system. For this reason, the host device is always required to have a plurality of transmission systems, and there are problems of complicated designing of the host device and of leading to increase in cost.

### Means to Solve the Problems

To solve the problems, a semiconductor memory card according to the present invention which transmits and receives a command and data via a plurality of signal lines to and from a host device and which is detachable with respect to the host device, comprises: a first interface (hereinafter referred to as IF) circuit for inputting and outputting a first IF signal; a second IF circuit for inputting and outputting a second IF signal; a first command receiving unit for receiving a command inputted to said first IF circuit; a second command receiving unit for receiving a command inputted to said second IF circuit; and an IF control unit for judging that said host device employs which one of said first IF circuit and said second IF circuit based on a reception result of a command received by said first command receiving unit and a reception result of a command received by said second command receiving unit.

Said IF control unit may set said first IF circuit and said second IF circuit to be an input status in turning a power on.

Said IF control unit may set either one of said first IF circuit and said second IF circuit to be in operation state and set another circuit to be in suspended state based on said judgment.

Said IF control unit may judge that said host device includes said first IF circuit when correctly receiving a received command at said first command receiving unit.

Said IF control unit may set said first IF circuit to be in operation state and set said second IF circuit to be in suspended state based on said judgment.

Said IF control unit may judge that said host device includes said second IF circuit when correctly receiving a received command at said second command receiving unit.

Said IF control unit may set said second IF circuit to be in operation state and set said first IF circuit to be in suspended state based on said judgment.

Said IF control unit may judge that a transmission system of said host device is said first IF circuit when correctly receiving a received command at said first command receiving unit and said second command receiving unit.

Said IF control unit may set said first IF circuit to be in operation state and set said second IF circuit to be in suspended state based on said judgment.

The semiconductor memory card may select either one of said first IF circuit and said second IF circuit based on setting of said host device.

Said first IF circuit may be a single-end signaling IF circuit and said second IF circuit may be a differential signaling IF circuit.

Said first IF circuit and said second IF circuit may be the single-end signaling IF circuits and voltage levels thereof are different each other.

Said second IF circuit to which a signal of level lower than that to said first IF circuit is inputted, may include a differential signaling circuit for comparing a signal of an input terminal to a ground voltage for each of the terminals.

### EFFECTIVENESS OF THE INVENTION

According to the present invention, the host device may have either one of transmission systems since a semiconductor memory card judges the transmission system employed by the host device and changes a transmission system. The host device can be easily designed without increasing a cost consequently.

### BRIEF DESCRIPTION OF DRAWINGS

FIG. 1 is a view showing a configuration of a semiconductor memory card in a first embodiment according to the present invention.

FIG. 2 is a view showing the configuration of the semiconductor memory card in the first embodiment according to the present invention.

FIG. 3 is a view showing a format of a command received by the semiconductor memory card in the first embodiment according to the present invention.

FIG. 4 is a view showing a terminal configuration in a case where the semiconductor memory card in the first embodiment according to the present invention connects to a host device employing a single-end signaling system.

FIG. 5 is a view showing a terminal configuration in a case where the semiconductor memory card in the first embodiment according to the present invention connects to a host device employing a differential signaling system.

FIG. 6 is a view showing an example of waveform of the single-end signaling system.

FIG. 7 is a view showing an example of waveform of the differential signaling system.

FIG. 8A is a waveform chart showing an operation of the semiconductor memory card in the first embodiment according to the present invention.

FIG. 8B is a waveform chart showing an operation of the semiconductor memory card in the first embodiment according to the present invention.

FIG. 8C is a waveform chart showing an operation of the semiconductor memory card in the first embodiment according to the present invention.

FIG. 8D is a waveform chart showing an operation of the semiconductor memory card in the first embodiment according to the present invention.

FIG. 9A is a waveform chart showing an operation of the semiconductor memory card in the first embodiment according to the present invention.

FIG. 9B is a waveform chart showing an operation of the semiconductor memory card in the first embodiment according to the present invention.

FIG. 9C is a waveform chart showing an operation of the semiconductor memory card in the first embodiment according to the present invention.

FIG. 9D is a waveform chart showing an operation of the semiconductor memory card in the first embodiment according to the present invention.

FIG. 10 is a view showing judgment in a command processing unit of the semiconductor memory card in the first embodiment according to the present invention.

FIG. 11 is a view showing a configuration of a semiconductor memory card in a second embodiment according to the present invention.

FIG. 12 is a view showing an example of waveform of a low-amplitude single-end signaling system.

FIG. 13A is a waveform chart showing an operation of the semiconductor memory card in the second embodiment according to the present invention.

FIG. 13B is a waveform chart showing an operation of the semiconductor memory card in the second embodiment according to the present invention.

FIG. 13C is a waveform chart showing an operation of the semiconductor memory card in the second embodiment according to the present invention.

FIG. 14A is a waveform chart showing an operation of the semiconductor memory card in the second embodiment according to the present invention.

FIG. 14B is a waveform chart showing an operation of the semiconductor memory card in the second embodiment according to the present invention.

FIG. 14C is a waveform chart showing an operation of the semiconductor memory card in the second embodiment according to the present invention.

FIG. 14D is a waveform chart showing an operation of the semiconductor memory card in the second embodiment according to the present invention.

FIG. 15 is a view showing judgment in a command processing unit of the semiconductor memory card in the second embodiment according to the present invention.

### EXPLANATION OF REFERENCE NUMERALS

1 Semiconductor memory card
2 Single-end signaling transmitting and receiving unit
3 Differential signaling transmitting and receiving unit
4 Command processing unit
5 Terminal group of the semiconductor memory card
6 Low-amplitude single-end signaling transmitting and receiving unit

### BEST MODE FOR CARRYING OUT THE INVENTION

### First Embodiment

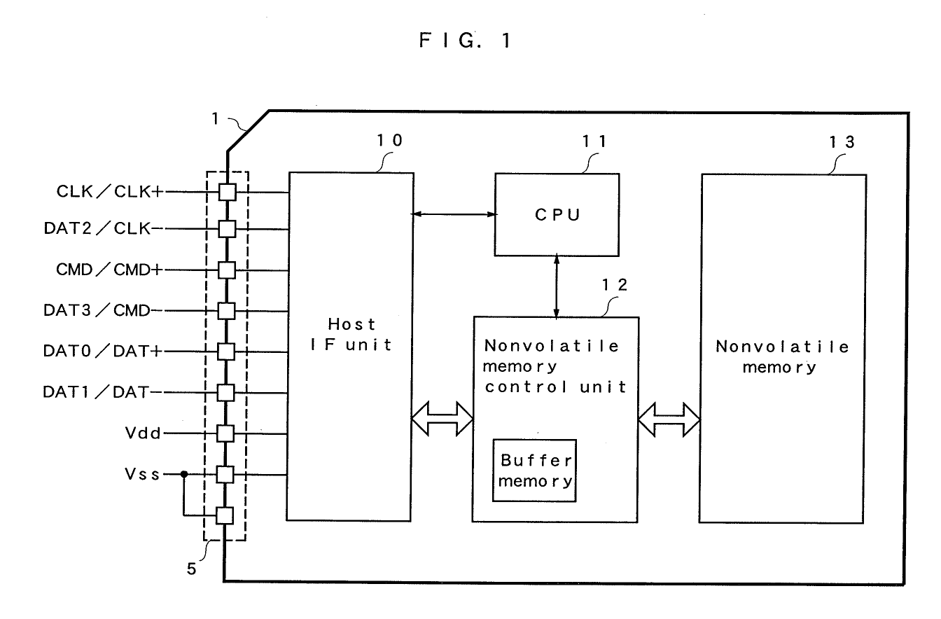

FIG. 1 shows a semiconductor memory card according to an embodiment of the present invention. A semiconductor memory card 1 includes a terminal group 5 for connecting to a host device, a host IF unit 10 for transmitting and receiving commands and data to and from the host device, a nonvolatile memory 13 that is a recording medium, a nonvolatile memory control unit 12 for inputting and outputting data from and to the nonvolatile memory 13, and a CPU 11 for inputting and outputting data in the nonvolatile memory 13 based on a command received from the host device.

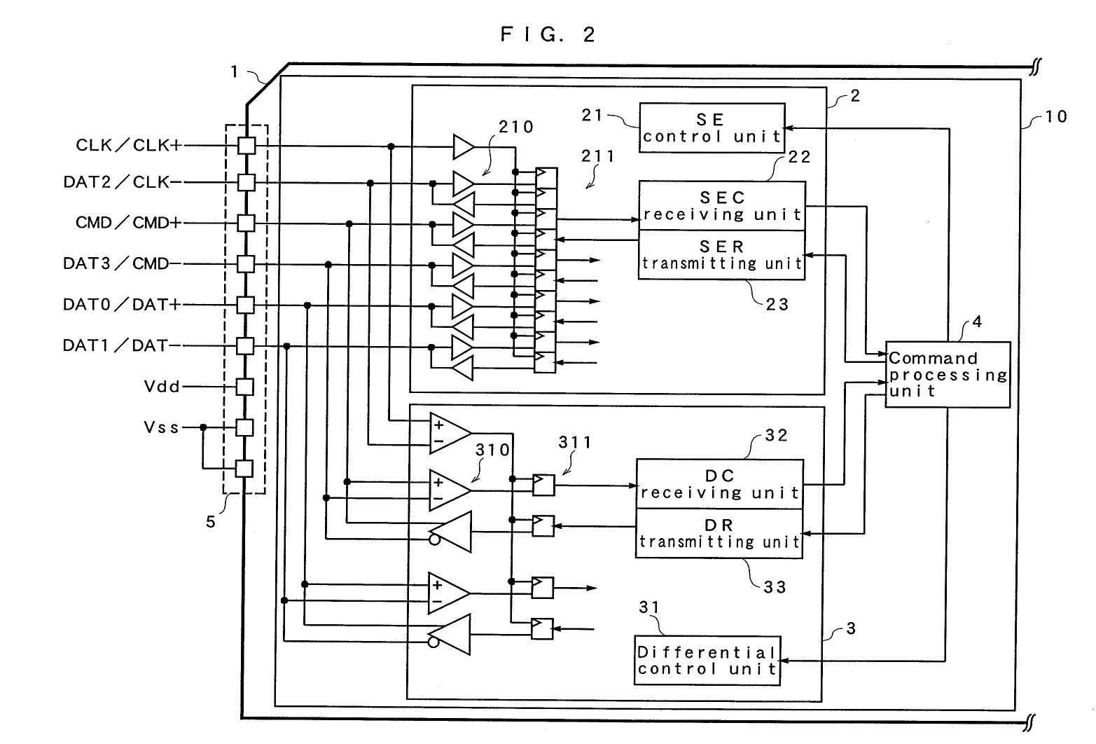

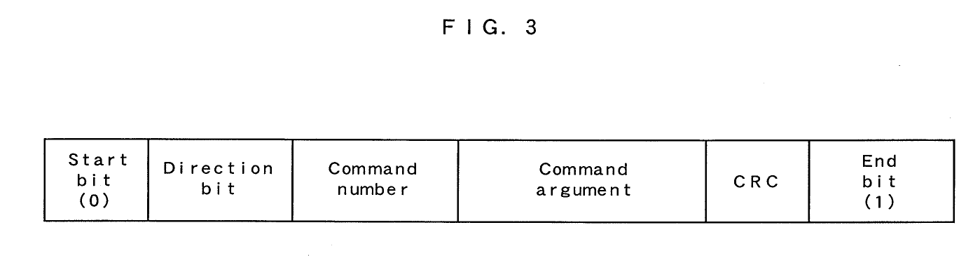

FIG. 2 shows configurations of the terminal group 5 and the host IF unit 10. The host IF unit 10 includes a single-end signaling transmitting and receiving unit 2, a differential signaling transmitting and receiving unit 3, and a command processing unit 4 in FIG. 2. FIG. 3 shows a format of a command received by the semiconductor memory card 1 from the host device. A start bit is a bit for indicating start of the command in FIG. 3, for example always being “0”. A direction bit is a bit for indicating a transfer direction of data, for example the direction bit is “1” if the transfer direction of data is from the host device to the semiconductor memory card 1. A command number indicates a type of command transmitted by the host device. A parameter used by the semiconductor memory card 1 for processing a command is set as a command argument. A CRC is data for protecting transfer of a command and data between the host device and the semiconductor memory card. An end bit is a bit for indicating termination of command transfer, for example always being “1”. Configurations of the respective units will be described below.

### (Configuration)

### (1) Terminal Group 5

The semiconductor memory card 1 according to the first embodiment of the present invention has nine terminals. Among them, one terminal is a power source terminal Vdd and two terminals are ground terminals Vss, and remaining six terminals are used as signal lines. The semiconductor memory card 1 includes two interface systems of the single-end signaling system and the differential signaling system as a transmission system.

A signal of the single-end signaling system that is a first interface system is composed of a clock signal CLK, a command response signal CMD, and data signals DAT0, DAT1, DAT2 and DAT 3. A signal of the differential signaling system that is a second interface system is composed of clock signals CLK+ and CLK−, command response signals CMD+ and CMD−, data signals DAT+ and DAT−. Pairs of the CLK and CLK+, the DAT2 and CLK−, the CMD and CMD+, the DAT3 and CMD−, the DAT0 and DAT+, and the DAT1 and DAT− respectively share the terminals, thus the semiconductor memory card 1 has a plurality of transmission systems without increasing the number of terminals.

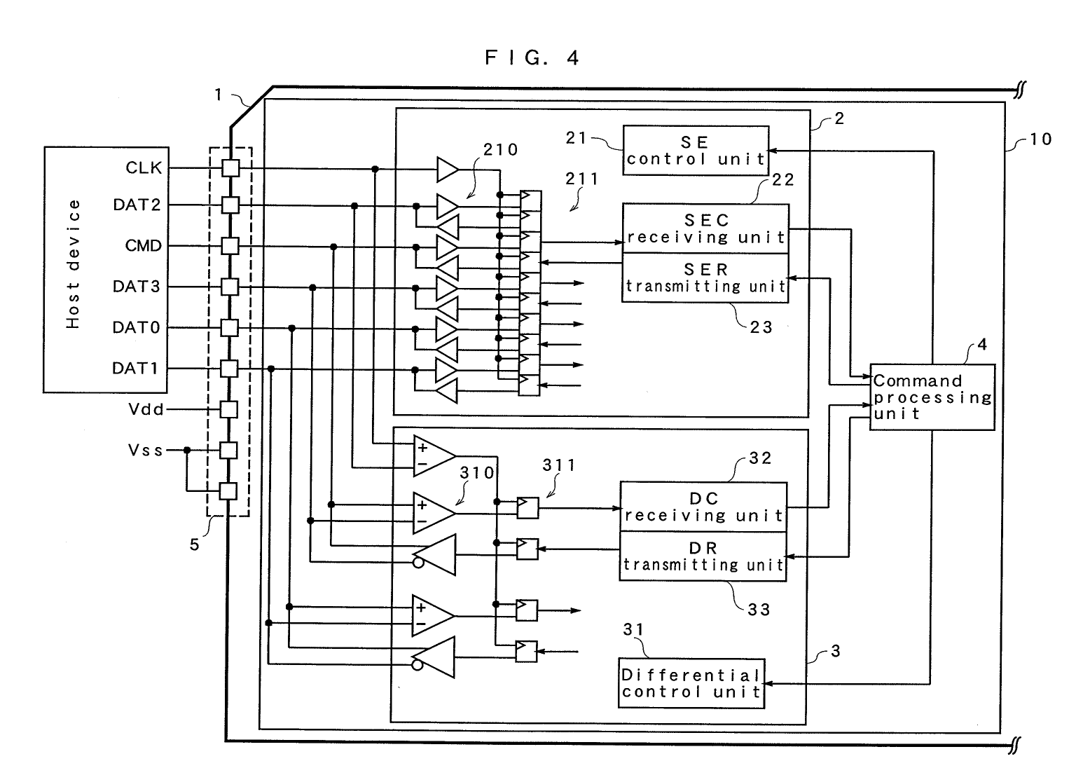

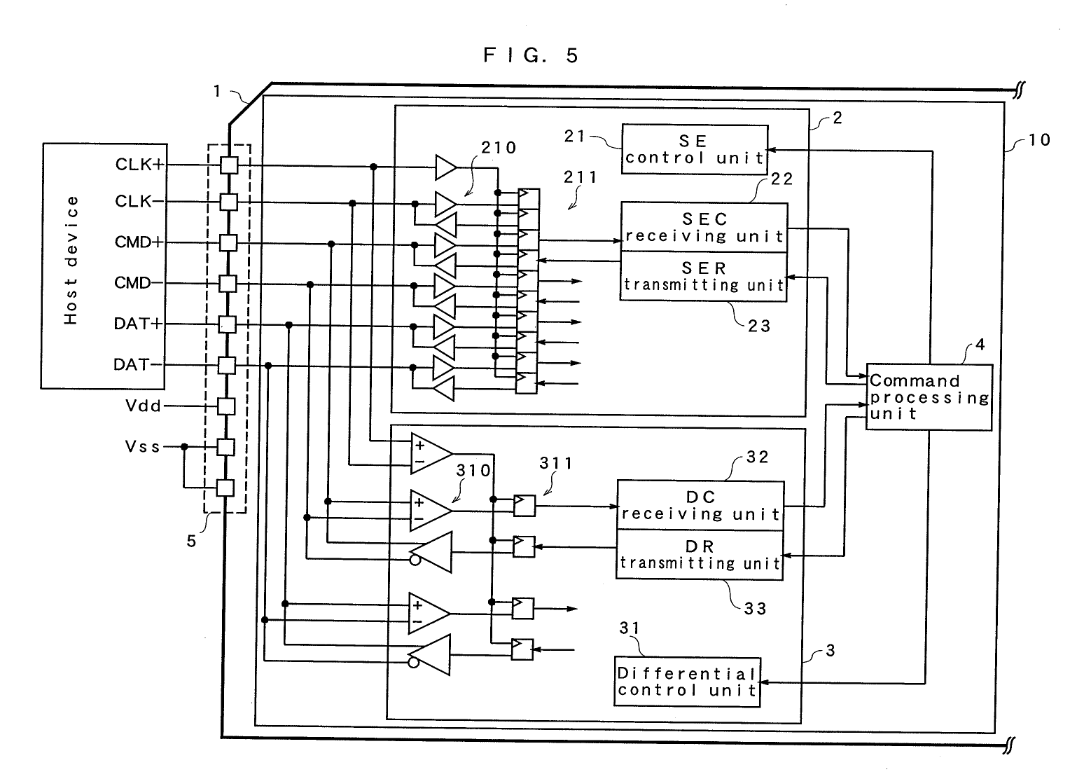

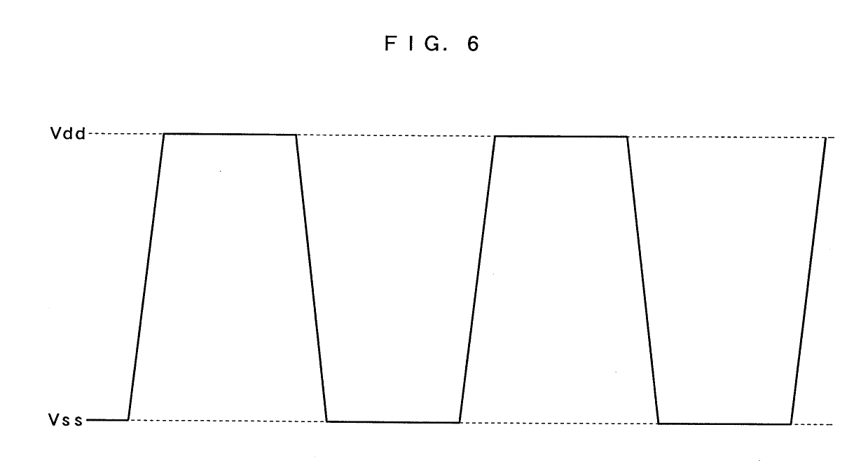

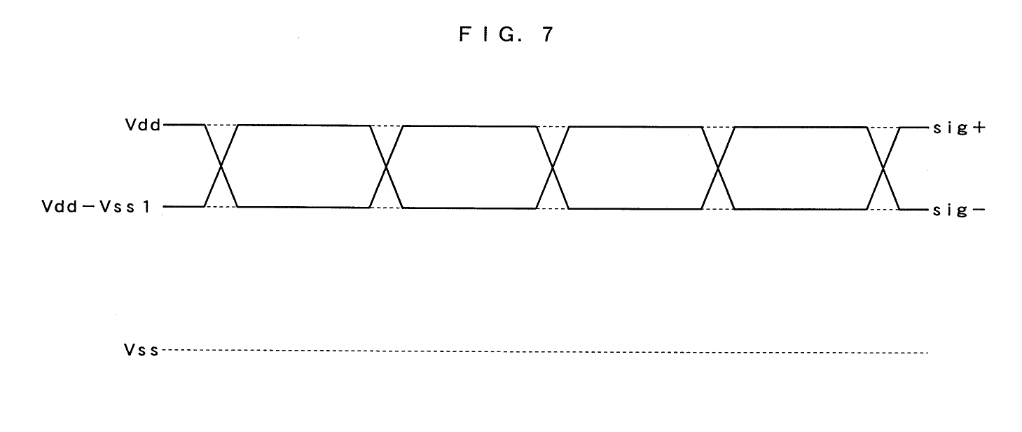

FIG. 4 shows a terminal configuration in a case where the semiconductor memory card 1 connects to the host device employing the single-end signaling system. FIG. 5 shows a terminal configuration in a case where the semiconductor memory card 1 connects to the host device employing the differential signaling system. FIG. 6 is an example of waveform of the single-end signaling system. A signal changes between the Vdd to the Vss in FIG. 6. FIG. 7 is an example of waveform of the differential signaling system. Two signals of sig+ and sig− are used for transmitting one-bit signal in FIG. 7, and the signals change between the Vdd and Vdd-Vss1 in a complementary manner. The sig+ and sig− in the differential signaling system are signals having amplitude of (Vdd-Vss1), respectively. The sig+ and sig− shows either one of combinations of the CLK+ and CLK−, the CMD+ and CMD−, or the DAT+ and DAT−.

### (2) Single-End Signaling Transmitting and Receiving Unit 2

The single-end signaling transmitting and receiving unit 2 includes a buffer circuit 210, a single-end signaling control unit 21, a latch circuit 211 for received signals, a single-end signaling command receiving unit 22, and a single-end signaling response transmitting unit 23.

### (2-1) Buffer Circuit 210

The buffer circuit 210 transmits and receives signals of the single-end signaling system via the terminal group 5 to and from the host device.

### (2-2) Single-End Signaling Control Unit 21

The single-end signaling control unit 21 performs a control of ON and OFF for the entire single-end signaling transmitting and receiving unit 2 in accordance with an instruction based on a received command by a command processing unit 4 described below.

### (2-3) Latch Circuit 211

The latch circuit 211 synchronizes the CMD, the DAT0 to DAT3 inputted via the buffer circuit 210 with the CLK inputted with them.

### (2-4) Single-End Signaling Command Receiving Unit 22

The single-end signaling command receiving unit 22 is a first command receiving unit, into which the CMD synchronized by the latch circuit 211 is inputted. Since a command is transmitted in a serial manner through a CMD terminal, the single-end signaling command receiving unit 22 judges a type of the command after converting the command into parallel data and informs the judgment result of the command processing unit 4.

### (2-5) Single-End Signaling Response Transmitting Unit 23

The single-end signaling response transmitting unit 23 generates a command response signal to the host device based on a control of the command processing unit 4.

The buffer circuit 210 and the latch circuit 211 configure a first IF circuit for inputting and outputting a first IF signal, and the single-end signaling command receiving unit 22 configures the first command receiving unit.

### (3) Differential Signaling Transmitting and Receiving Unit 3

The differential signaling transmitting and receiving unit 3 includes a differential signaling transmitting and receiving circuit 310, a differential signaling control unit 31, a latch circuit 311 for received signals, a differential signaling command receiving unit 32, and a differential signaling response transmitting unit 33.

### (3-1) Differential Signaling Transmitting and Receiving Circuit 310

The differential signaling transmitting and receiving circuit 310 transmits and receives signals of the differential signaling system via the terminal group 5 to and from the host device. The differential signaling transmitting and receiving circuit 310 detects a difference between the input signals sig+ and sig− and converts the received signals into one bit signal of “0” or “1” when receiving signals. The differential signaling transmitting and receiving circuit 310 also generates two signals of the sig+ and sig− having complementary signal waveform based on a value of signal to be outputted (“0” or “1”) when transmitting signals.

### (3-2) Differential Signaling Control Unit 31

The differential signaling control unit 31 performs a control of ON and OFF for the entire difference transmitting and receiving unit 3 in accordance with an instruction based on a received command by the command processing unit 4 described below.

### (3-3) Latch Circuit 311

The latch circuit 311 synchronizes the CMD and the DAT outputted by the differential signaling transmitting and receiving circuit 310 with the CLK.

### (3-4) Differential Signaling Command Receiving Unit 32

The differential signaling command receiving unit 32 is a second command receiving unit, which receives the CMD synchronized by the latch circuit 311 as a command transmitted by the host device. Since a command is transmitted in a serial manner through a CMD+ terminal and a CMD− terminal, the differential signaling command receiving unit 32 judges a type of the command after converting the command into parallel data and informs the judgment result to the command processing unit 4.

### (3-5) Differential Signaling Response Transmitting Unit 33

The differential signaling response transmitting unit 33 generates a command response signal to the host device based on a control of the command processing unit 4.

The differential signaling transmitting and receiving circuit 310 and the latch circuit 311 configure a second IF circuit for inputting and outputting a second IF signal, and the differential signaling command receiving unit 32 configures the second command receiving unit for receiving a command inputted to the second IF circuit.

### (4) Command Processing Unit 4

The command processing unit 4 is an interface control unit for judging whether the transmission system employed by the host device is the single-end signaling system or the differential signaling system based on reception results of the single-end signaling command receiving unit 22 and the differential signaling command receiving unit 32. The command processing unit 4 instructs the single-end signaling control unit 21 and the differential signaling command control unit 31 to set the single-end signaling control unit 2 and the differential signaling control unit 3 to be ON or OFF based on the judgment result. In addition, the command processing unit 4 orders the response transmitting units 23 or 33 of the selected transmission system to transmit a command response signal to the host device. The command processing unit 4 does not order the response transmitting units 23 or 33 of the transmission system that is not selected to transmit a command response signal to the host device.

### (Operation)

An operation of the semiconductor memory card 1 according to the first embodiment of the present invention will be described next. The semiconductor memory card 1 is detachable from the host device, and is able to connect to each of a host device employing the single-end signaling system and a host device employing the differential signaling system. When connecting to the host device and power is turned on, the semiconductor memory card 1 sets both of the single-end signaling transmitting and receiving unit 2 and the differential signaling transmitting and receiving unit 3 to be an ON status and an input status, and waits for receiving a command from the host device. The ON status means a status where the single-end signaling transmitting and receiving unit 2 and the differential signaling transmitting and receiving unit 3 can process a command from the host device. The input status means a status where the transmitting and receiving units 2 and 3 can receive a command from the host device, and the buffer circuits 210 and 310 are in a reception status.

DAT0, DAT1, DAT2, and DAT3 terminals are retained to Vdd because of the pull-up in the host device employing the single-end signaling system, which is not shown in the figure. The input status and output status are changed depending on whether or not an output of the buffer circuit 210 is enabled. If the output is valid, the terminals are in the output status, and if the output is disabled, the terminals are in the input status. As described above, when receiving a command signal and a data signal from the host device, the terminals are in the input status. When transmitting a response signal and a data signal to the host device, the terminals are in the output status.

A case of connecting to the host device having an interface of the single-end signaling system as shown in FIG. 4 and a case of connecting to the host device having an interface of the differential signaling system as shown in FIG. 5 will be described below.

### (1) Case of Connecting to the Host Device Having an Interface of the Single-End Signaling System

### (1-1) Operation of the Single-End Signaling Transmitting and Receiving Unit 2

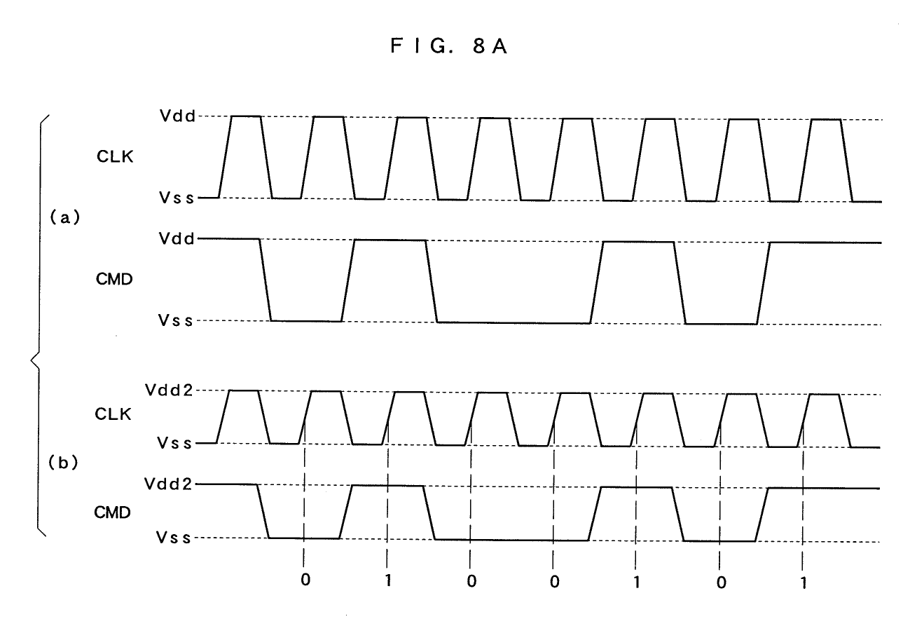

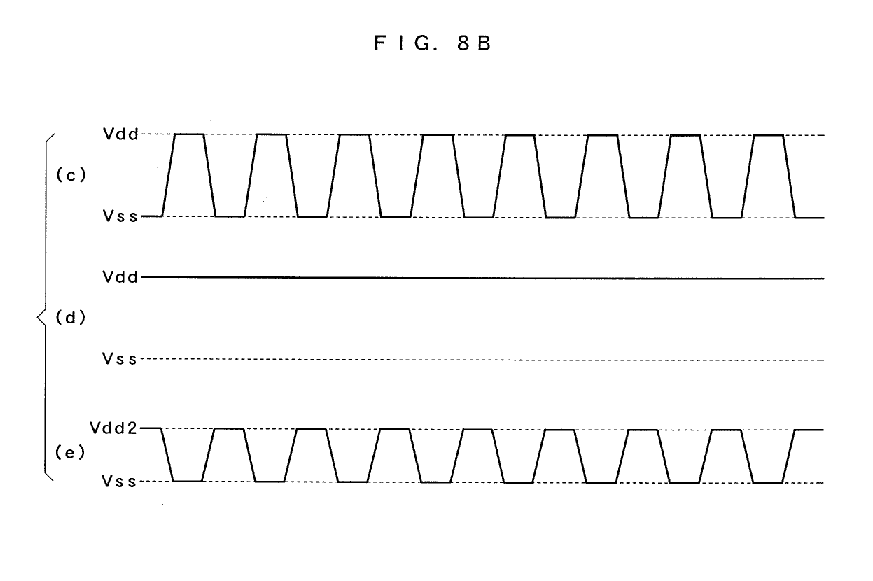

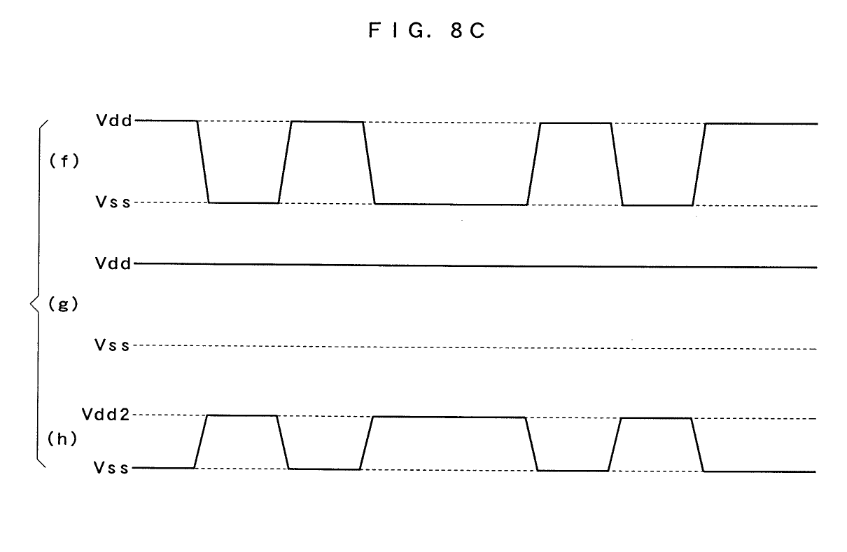

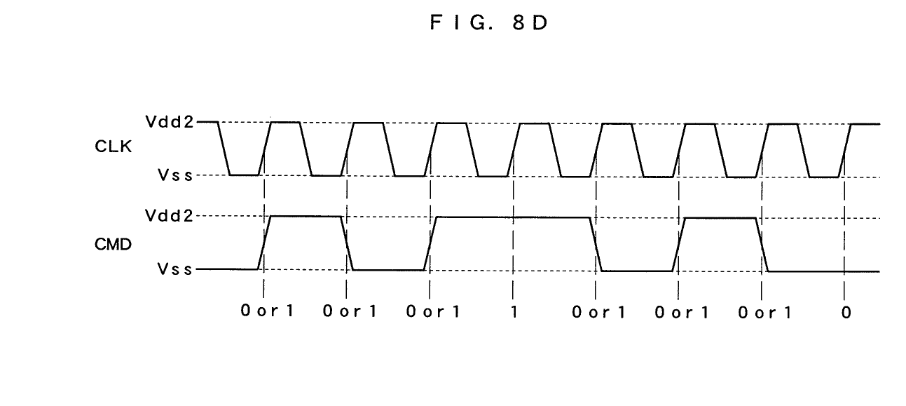

FIG. 8A shows a waveform chart in respective units in a case of receiving a command signal from the host device employing the single-end signaling system. FIG. 8A(a) shows waveforms of the CLK and CMD in the CLK terminal and the CMD terminal, and the signals change between Vdd and Vss. FIG. 8A(b) shows waveforms of CLK and CMD received by the buffer circuit 210 of the single-end signaling transmitting and receiving unit 2, and signal levels are converted into an operation voltage Vdd2 in the semiconductor memory card 1 by the buffer circuit 210. The CMD signal is synchronized correctly with the CLK signal by the latch circuit 211 as shown in lower unit of FIG. 8A(b), and it can be judged correctly whether a signal is “0” or “1”. The single-end signaling command receiving unit 22 receives a command correctly and informs a command number and an argument to the command processing unit 4. The signal is synchronized at a point of rising of the CLK signal from “0” to “1” in the present embodiment.

### (1-2) Operation of the Differential Signaling Transmitting and Receiving Unit 3

FIG. 8B and FIG. 8C show waveforms of input and output signals in the differential signaling transmitting and receiving circuit 310 of the differential signaling transmitting and receiving unit 3. FIG. 8B(c) and FIG. 8B(d) show waveforms of input and output signals of the CLK+ and CLK− in the receiving circuit 310, respectively. FIG. 8B(e) shows a waveform obtained from a difference between the CLK+ and CLK−. FIG. 8C(f) and FIG. 8C(g) show waveforms of input and output signals of the CLK+ and CLK− in the receiving circuit 310, respectively. FIG. 8C(h) shows a waveform obtained from a difference between the CLK+ and CLK−.

When the host device employs the single-end signaling system, CLK is inputted to the CLK+ terminal as shown in FIG. 8B(c), and DAT2 is inputted to the CLK− terminal as shown in FIG. 8B(d). Since pull-up is performed on the DAT2 terminal (the CLK− terminal) as described above, an input waveform of between two signals is reversed as shown in FIG. 8B(e). When a signal level in FIG. 8B(e) is Vdd2, one bit signal of “0” or “1” is outputted to the latch circuit 311. Similarly, CMD is inputted to the CMD+ terminal as shown in FIG. 8C(f) and DAT3 is inputted to the CMI− terminal as shown in FIG. 8C(g). Since the pull-up is also performed on the DAT 3 (the CLK− terminal), an input waveform of a difference between two signals is reversed as shown in FIG. 8C(h). When a signal level in FIG. 8C(h) is Vdd2, one bit signal of “0” or “1” is outputted to the latch circuit 311. As described above, timings of rising of the CLK signal and of changing of the CMD signal are sometimes coincident with each other because the reversed CLK and CMD signals are outputted together, and correct synchronization of a command signal in the latch circuit 311 cannot be assured. The signal, accordingly, cannot be judged whether “0” or “1” correctly, and a command number and an argument may be incorrect values. The incorrect value means a command number or an argument which cannot be processed by the semiconductor memory card 1. The value corresponds to an undefined command number and argument and to a command number and argument which cannot be processed because of an internal state of the semiconductor memory card. The differential signaling command receiving unit 32 informs a result of receiving a command to the command processing unit 4.

### (2) Case of Connecting to the Host Device Having an Interface of the Differential Signaling System

### (2-1) Operation of the Single-End Signaling Transmitting and Receiving Unit 2

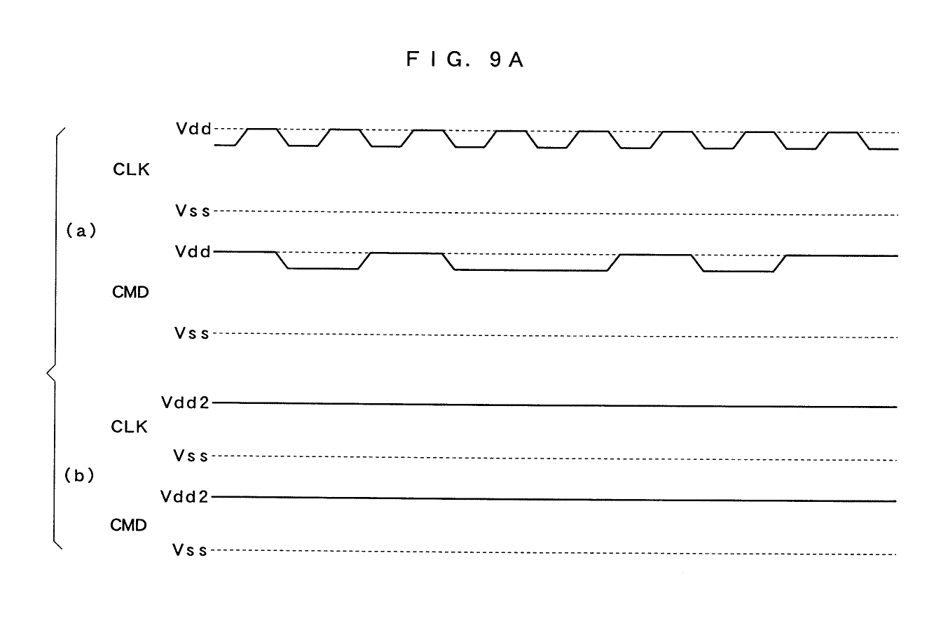

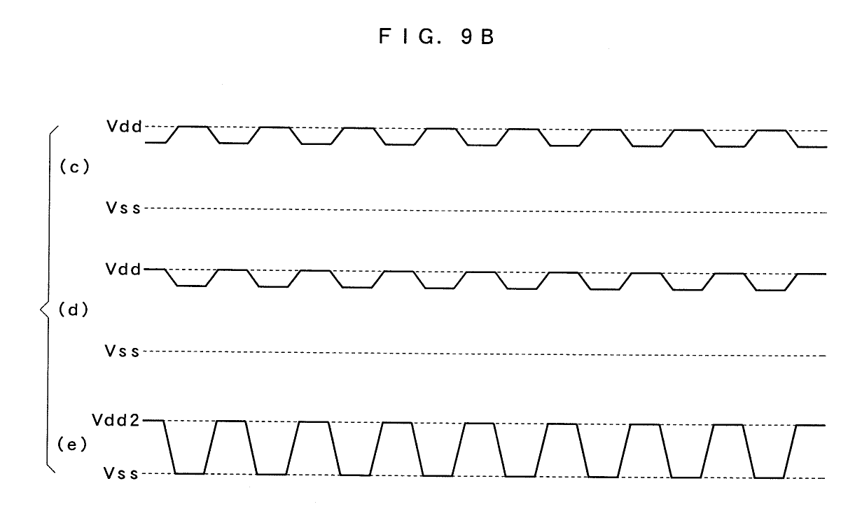

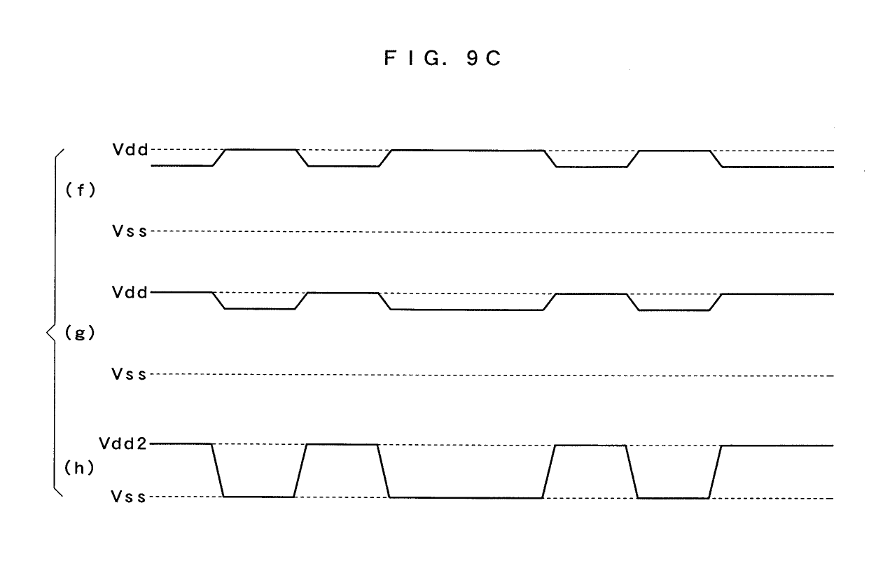

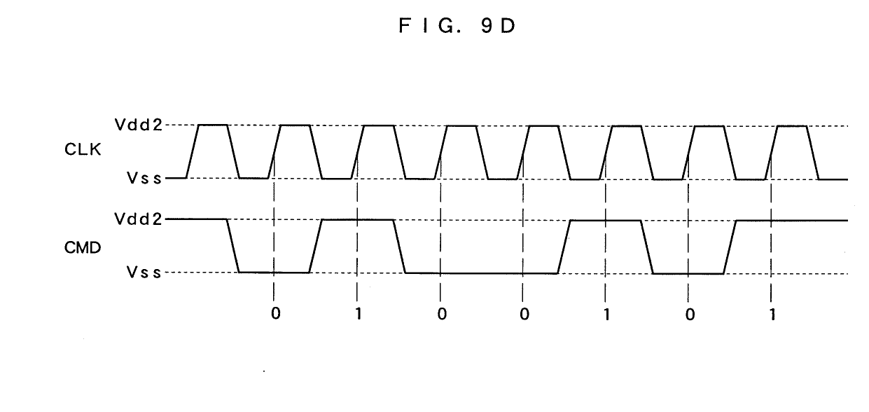

FIG. 9A to FIG. 9D show signal waveforms of respective units in a case of receiving a command from the host device employing the differential signaling system. FIG. 9A(a) shows waveforms of input signals in the CLK and CMD terminals, respectively. The signals change between Vdd and Vdd-Vss1. FIG. 9A(b) shows signal waveforms of CLK and CMD received by the buffer circuit 210 in the single-end signaling transmitting and receiving unit 2. Since being small, amplitude of a differential signaling signal is always recognized as a high level in the buffer circuit 210. For this reason, CMD cannot be synchronized in the latch circuit 211 correctly and the single-end signaling command receiving unit 22 cannot recognize a command reception.

### (2-2) Operation of the Differential Signaling Transmitting and Receiving Unit 3

FIG. 9B and FIG. 9C show waveforms of input and output signals in the differential signaling transmitting and receiving circuit 310 of the differential signaling transmitting and receiving unit 3. FIG. 9B(c) and FIG. 9B(d) show waveforms of input and output signals of the CLK+ and CLK− in the receiving circuit 310, respectively. FIG. 9B(e) shows a waveform obtained from a difference between the CLK+ and CLK−. FIG. 9C(f) and FIG. 9C(g) show waveforms of input and output signals of the CLK+ and CLK− in the receiving circuit 310, respectively. FIG. 9C(h) shows a waveform obtained from a difference between the CMD+ and CMD−. If the host device has an interface of the differential signaling system, CLK+ of a signal waveform shown in FIG. 9B(c) is inputted to the CLK+ terminal and CLK− of a signal waveform shown in FIG. 9B(d) is inputted to the CLK− terminal. Differential signaling between the two signals forms a signal waveform shown in FIG. 9B(e) and is outputted as a signal of signal level Vdd2.

Similarly, CLK+ of a signal waveform shown in FIG. 9C(f) is inputted to the CLK+ terminal and CLK− of a signal waveform shown in FIG. 9C(g) is inputted to the CLK− terminal. The differential signaling transmitting and receiving circuit 310 detects a difference between input signals, converts a signal of a waveform shown in FIG. 9C(h) whose signal level is Vdd2 into one bit signal of “0” or “1” and outputs the signal to the latch circuit 311. The signal, accordingly, is synchronized correctly at a point of rising of the CLK signal by the latch circuit 311 as shown in FIG. 9D, and it is judged whether the signal is “0” or “1”. As a result, the differential signaling command receiving unit 32 is able to receive a command correctly and informs a result to the command processing unit 4.

### (3) Operation of the Command Processing Unit 4

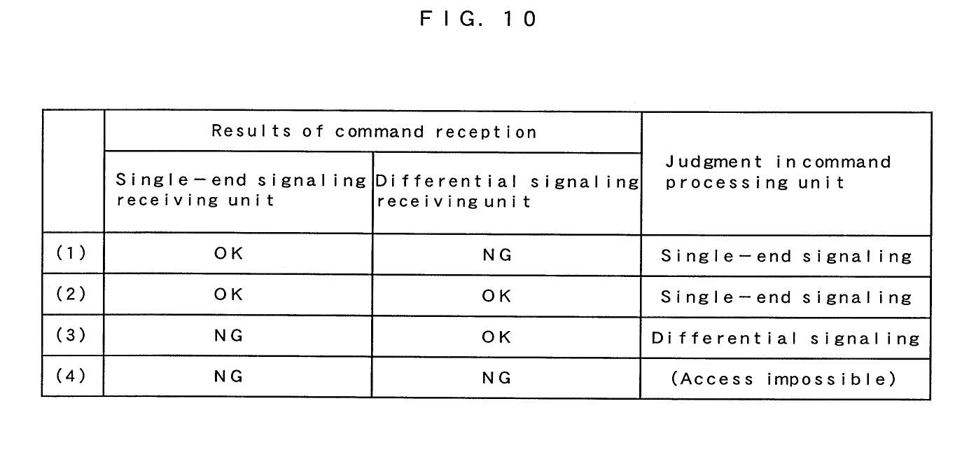

FIG. 10 shows a reception result in the single-end signaling command receiving unit 22 and the differential signaling command receiving unit 32, and shows a determination result in the command processing unit 4. “OK” in FIG. 10 indicates correct recognition of command reception, and “NG” indicates a case where recognition of command reception is impossible or where an incorrect command was received. The case where recognition of command reception is impossible means a case where there is no information showing “command was recognized” in the command reception units 22 and 32.

When the memory card is connected to the host device employing the single-end signaling system, a result of command reception in the single-end signaling command reception unit 22 and the differential signaling command reception unit 32 is shown as those in (1) or (2) in FIG. 10 and thereby the command processing unit 4 determines that the host device employs the single-end signaling system. The command processing unit 4, based on the determination, orders the differential signaling control unit 31 to turn the differential signaling transmitting and receiving unit 3 OFF and orders the single-end signaling response transmitting unit 23 to transmit a command response signal to the host device. The semiconductor memory card 1 transmits and receives data to and from the host device with using the single-end signaling transmitting and receiving unit 2 subsequently.

Since a result of command reception in the single-end signaling command reception unit 22 and the differential signaling command reception unit 32 is shown as that in (3) in FIG. 10 in connecting to the host device employing the differential signaling system, the command processing unit 4 determines that the host device employs the differential signaling system. The command processing unit 4 orders the single-end signaling control unit 2 to turn the single-end signaling transmitting and receiving unit 2 OFF and orders the differential signaling response transmitting unit 33 to transmit a command response signal to the host device. The semiconductor memory card 1 transmits and receives data to and from the host device with using the differential signaling transmitting and receiving unit 3 subsequently. As described above, when the detachable semiconductor memory card 1 is connected to a host device, a type of an interface of the host device is automatically judged and data can be transmitted and received.

### Second Embodiment

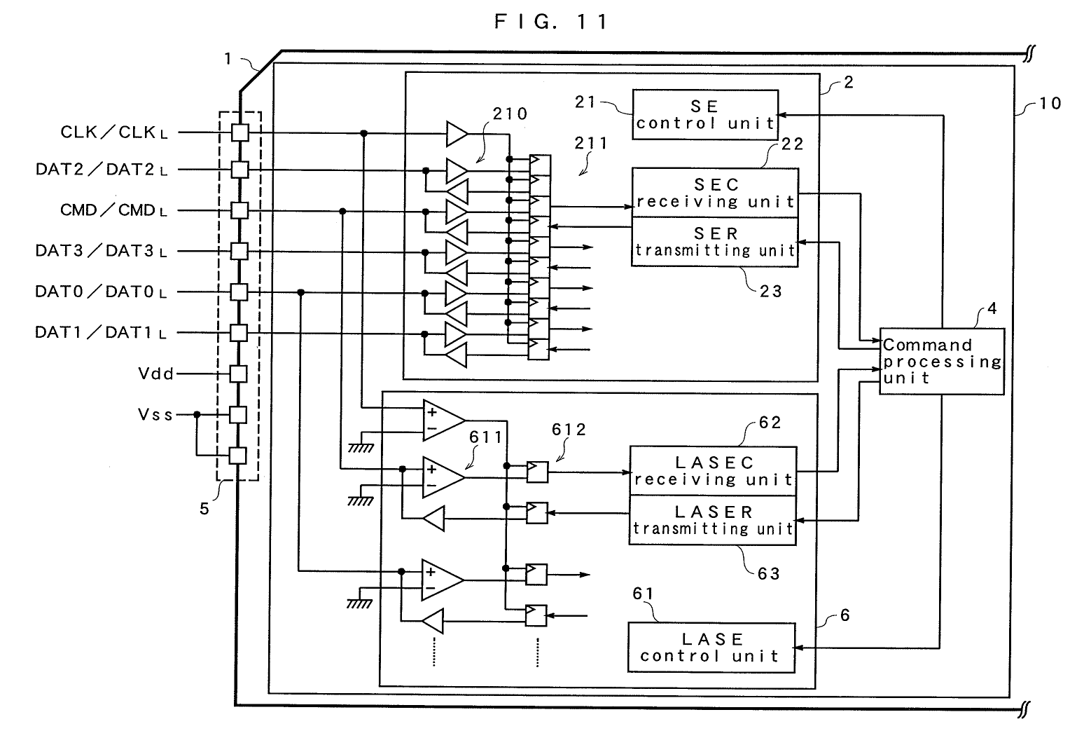

The semiconductor memory card 1 according to the first embodiment described above employs two transmission systems of the single-end signaling system and the differential signaling system. A semiconductor memory card 1 may, as shown in FIG. 11, employ a low-amplitude single-end signaling system as the second IF system in stead of the differential signaling system. A second embodiment will describe the semiconductor memory card employing such systems. Other configurations such as a configuration of the semiconductor memory card 1 and a format of a command from the host device received by the semiconductor memory card 1 are the same as those of the first embodiment.

### (Configuration)

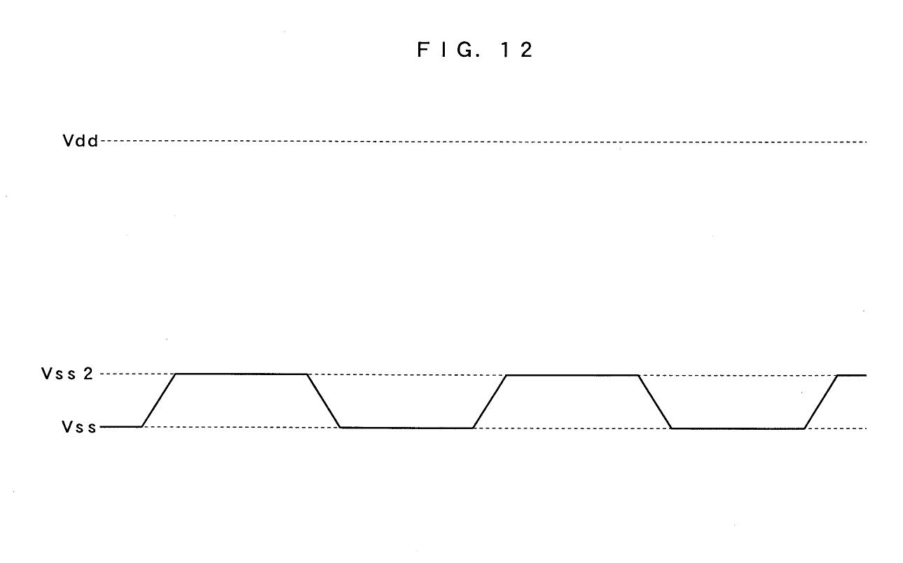

The semiconductor memory card 1 according to the second embodiment of the present invention includes a low-amplitude single-end signaling transmitting and receiving unit 6 as shown in FIG. 11. The semiconductor memory card 1 according to the second embodiment uses a differential signaling transmitting and receiving circuit 611 as a transmitting and receiving circuit of the low-amplitude single-end signaling system. The low-amplitude single-end signaling transmitting and receiving unit 6 has the same configuration as that of the command processing unit 4 of the semiconductor memory card 1 according to the first embodiment described above other than that −(minus) input sides of respective operation amplifiers in the differential signaling transmitting and receiving circuit 611 are grounded to be in a state where “0” is constantly inputted, that a receiving circuit for a command signal is a low-amplitude single-end signaling command receiving unit 62, and that a transmitting circuit is a low-amplitude single-end signaling response transmitting unit 63. In addition, configurations of the differential signaling transmitting and receiving circuit 611 and the latch circuit 612 with respect to DAT1, DAT2, and DAT3 are the same, which are abbreviated in FIG. 11. The differential signaling transmitting and receiving circuit 611 and the latch circuit 612 configure a second IF circuit, and the low-amplitude single-end signaling command receiving unit 62 configures a second command receiving unit for receiving a command signal inputted to the second IF circuit. FIG. 12 shows an example of a signal waveform of the low-amplitude single-end signaling system.

### (Operation)

An operation of the semiconductor memory card 1 according to the second embodiment of the present invention will be described. The semiconductor memory card 1 is detachable and is able to connect to each of a host device employing the single-end signaling system and a host device employing the low-amplitude single-end signaling system. When connecting to a host device and power is turned on, the semiconductor memory card 1 sets both of the single-end signaling transmitting and receiving unit 2 and the low-amplitude single-end signaling transmitting and receiving unit 6 to be in an ON status and an input status, and waits for a received command from the host device. Pull-up is performed on the DAT0, DAT1, DAT2, and DAT3 terminals in the host device employing the single-end signaling system, which is not shown in the figure. A case of connecting to the host device employing the single-end signaling system and a case of connecting to the host device employing the low-amplitude single-end signaling system will be described below.

### (1) A Case of Connecting to the Host Device Employing the Single-End Signaling System

### (1-1) Operation of the Single-End Signaling Transmitting and Receiving Unit 2

An operation of the single-end signaling transmitting and receiving unit 2 is the same as that of the case described by using FIGS. 8A(a) and (b). The single-end signaling transmitting and receiving unit 2 receives a command correctly and informs it to the command processing unit 4.

### (1-2) Operation of the Low-Amplitude Single-End Signaling Transmitting and Receiving Unit 6

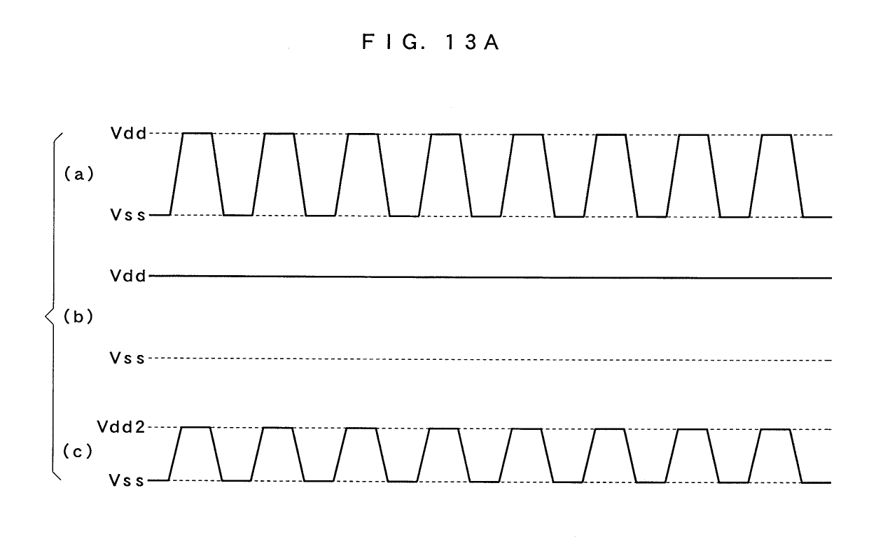

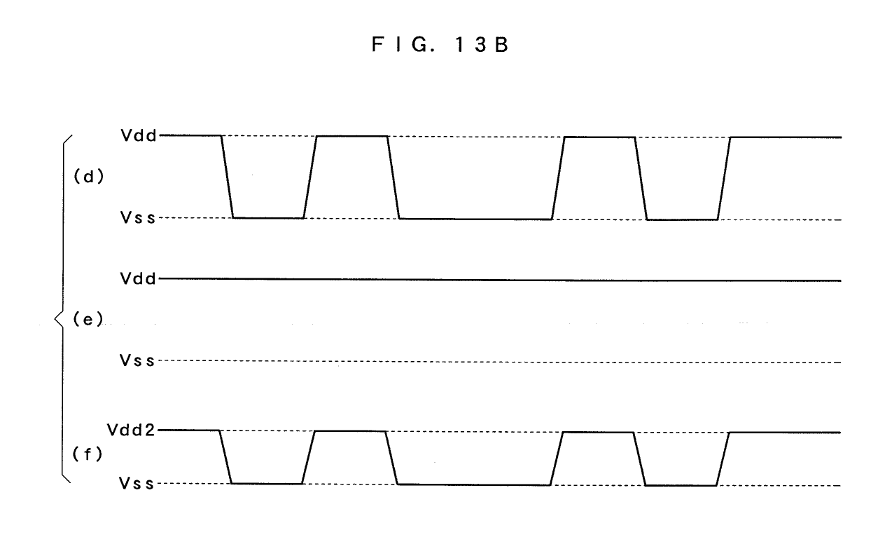

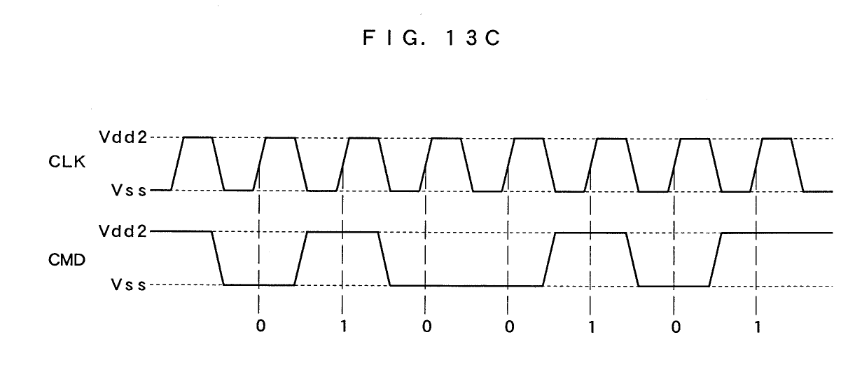

FIG. 13A and FIG. 13B show waveforms of input and output signals in the transmitting and receiving circuit 611 of the low-amplitude single-end signaling transmitting and receiving unit 6. FIG. 13A(a) and FIG. 13A(b) show waveforms of input and output signals of a CLK receiving circuit in the transmitting and receiving circuit 611. FIG. 13A(c) shows a waveform obtained from a difference between a +(plus) input and −(minus) input to the CLK receiving circuit. FIG. 13B(d) and FIG. 13B(e) show waveforms of the CMD receiving circuit. FIG. 13B(f) shows a waveform obtained from a difference between a +(plus) input and −(minus) input to the CMD receiving circuit.

When the host device employs the single-end signaling system, CLK having a signal waveform shown in FIG. 13A(a) is inputted to the +(plus) input to the CLK receiving circuit. The −(minus) input to the CLK receiving circuit is grounded as shown in FIG. 13A(b) to be in a state where “0” is constantly inputted. A difference between the two signals changes to one bit signal of “0” or “1” with signal level of Vdd2 that is shown as an input waveform thereof in FIG. 13A(c) and is outputted to the latch circuit 612. Similarly, CMD having a signal waveform shown in FIG. 13B(d) is inputted to the +(plus) input to the CMD receiving circuit, and the −(minus) input to the CMD receiving circuit is grounded as shown in FIG. 13B(e). A difference between the two signals changes to one bit signal of “0” or “1” with signal level of Vdd2 that is shown as an input waveform thereof in FIG. 13A(c) and is outputted to the latch circuit 612. An output signal, accordingly, is synchronized correctly at a point of rising of the CLK signal in the latch circuit 612 as shown in FIG. 13C and is judged whether “0” or “1”. As a result, the low-amplitude single-end signaling command receiving unit 62 receives a command signal correctly and informs the result to the command processing unit 4.

### (2) A Case of Connecting to the Host Device Employing the Low-Amplitude Single-End Signaling System

### (2-1) Operation of the Single-End Signaling Transmitting and Receiving Unit

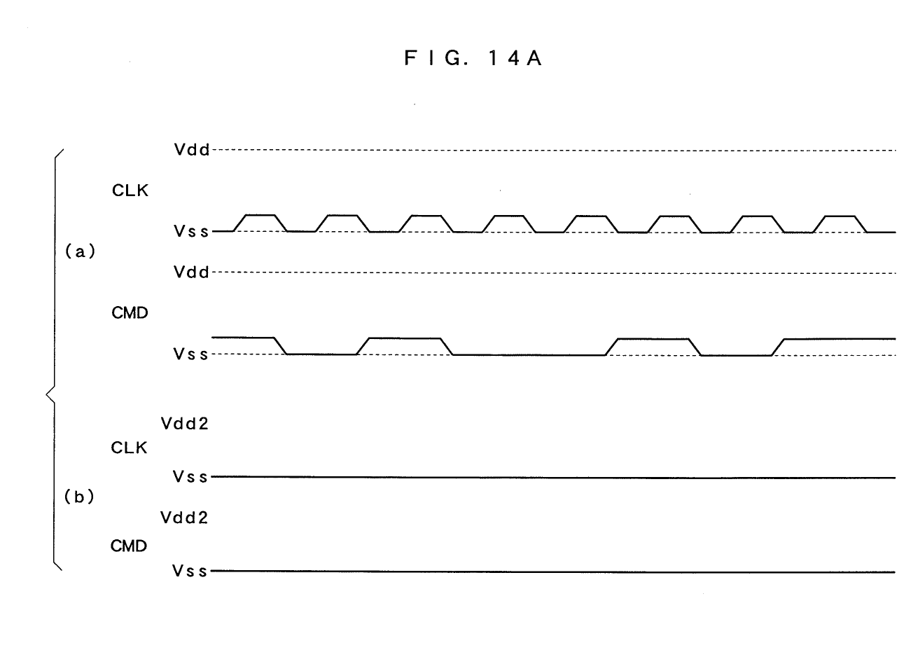

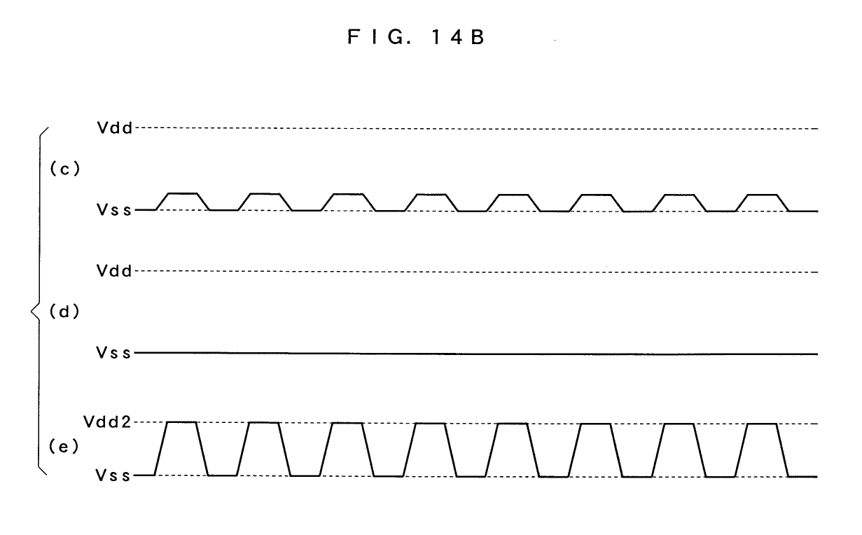

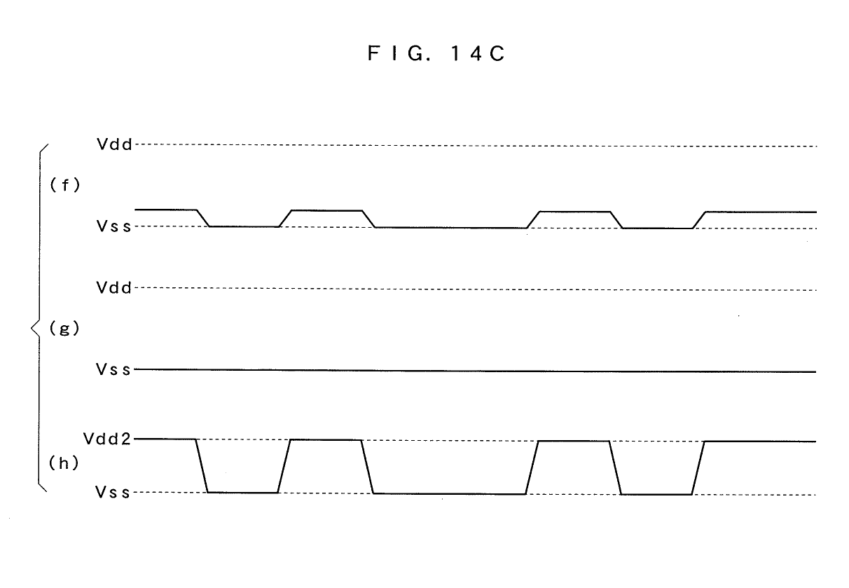

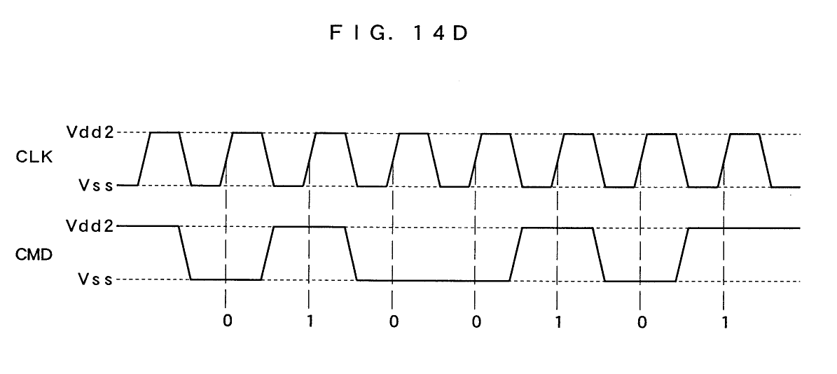

FIG. 14A to FIG. 14C show signal waveforms of respective units in a case of receiving a command from the host device employing the low-amplitude single-end signaling system. FIG. 14A(a) shows waveforms of the CLK and CMD at terminals, and the signals change within a range between Vdd and Vss. FIG. 14A(b) shows signal waveforms of CLK and CMD received by the buffer circuit 210 in the single-end signaling transmitting and receiving unit 2. Since amplitude of the low-amplitude single-end signaling signal is narrow, the low-amplitude single-end signaling signal is always recognized as a low level in the buffer circuit 210. For this reason, a signal outputted from the buffer circuit 210 cannot be synchronized in the latch circuit 211 correctly and the single-end signaling command receiving unit 22 cannot recognize reception of a command.

### (2-2) Operation of the Low-Amplitude Single-End Signaling Transmitting and Receiving Unit

FIG. 14B and FIG. 14C show waveforms of input and output signals in the transmitting and receiving circuit 611 of the low-amplitude single-end signaling transmitting and receiving unit 6. FIG. 14B(c) and FIG. 14B(d) show waveforms of input and output signals of a CLK receiving circuit. FIG. 14B(e) shows a waveform obtained from a difference between a +(plus) input and −(minus) input to the CLK receiving circuit. FIG. 14C(f) and FIG. 14C(g) show waveforms of input and output signals of the CMD receiving circuit. FIG. 14C(h) shows a waveform obtained from a difference between a +(plus) input and −(minus) input to the CMD receiving circuit. When the host device employs the low-amplitude single-end signaling system, a signal having a signal waveform shown in FIG. 14B(c) is inputted to the +(plus) input to the CLK receiving circuit. The −(minus) input to the CLK receiving circuit is grounded to be in a state where “0” is constantly inputted as shown in FIG. 14B(d). A difference between the two signals changes to a signal with a signal level of Vdd2 that is shown as an input waveform thereof in FIG. 14B(e) and is outputted.

A signal having a waveform shown in FIG. 14C(f) is inputted to the +(plus) input to the CMD receiving circuit. Since the −(minus) input to the CMD receiving circuit is grounded and “0” is constantly inputted as shown in FIG. 14C(g), a difference between the two signals changes to a signal with a signal level of Vdd2 that is shown as an input waveform thereof in FIG. 14C(h) and is outputted. An output signal, accordingly, is synchronized correctly at a rising edge of the CLK signal by the latch circuit 612 as shown in FIG. 14D and is judged whether “0” or “1”. As a result, the low-amplitude single-end signaling command receiving unit 62 receives a command signal correctly and informs the result to the command processing unit 4.

### (3) Operation of the Command Processing Unit 4

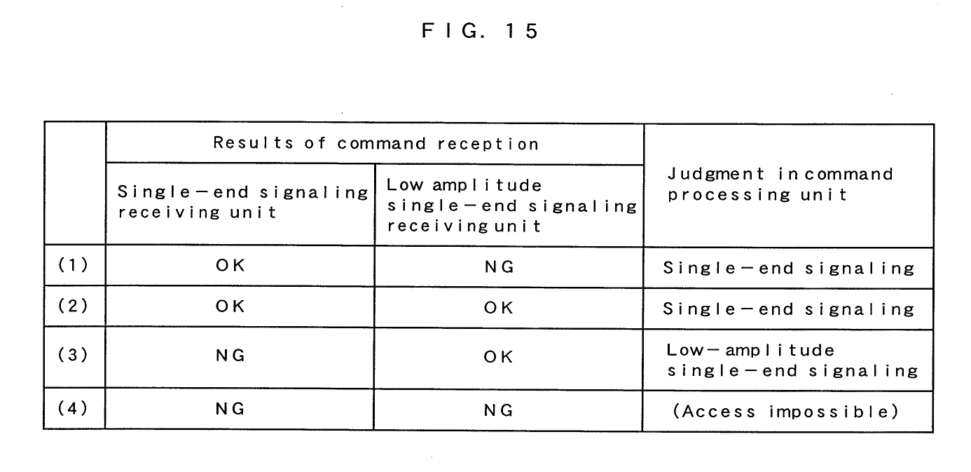

FIG. 15 shows a reception result in the single-end signaling command receiving unit 22 and the low-amplitude single-end signaling command receiving unit 62, and shows a determination result in the command processing unit 4. “OK” in the figure indicates correct recognition of command reception, and “NG” indicates a case where recognition of command reception is impossible or where an incorrect command was received.

When the semiconductor memory card 1 in FIG. 11 connects to the host device employing the single-end signaling system, the command processing unit 4 determines that the host device employs the single-end signaling system since results of command reception in the single-end signaling command reception unit 22 and the low-amplitude single-end signaling command receiving unit 62 are shown as those in (2) in FIG. 15. The command processing unit 4 orders the low-amplitude single-end signaling control unit 61 to turn the low-amplitude single-end signaling transmitting and receiving unit 6 OFF and orders the single-end signaling response transmitting unit 23 to transmit a command response signal to the host device. The semiconductor memory card 1 transmits and receives data to and from the host device using the single-end signaling transmitting and receiving unit 2 subsequently.

When the semiconductor memory card 1 shown in FIG. 11 connects to the host device employing the low-amplitude single-end signaling system, the command processing unit 4 determines that the host device employs the low-amplitude single-end signaling system since results of command reception in the single-end signaling command reception unit 22 and the low-amplitude single-end signaling command receiving unit 62 are shown as those in (3) in FIG. 15. The command processing unit 4 orders the single-end signaling control unit 21 to turn the single-end signaling transmitting and receiving unit 2 OFF and orders the low-amplitude single-end signaling response transmitting unit 63 to transmit a command response signal to the host device. The semiconductor memory card 1 transmits and receives data to and from the host device with using the low-amplitude single-end signaling transmitting and receiving unit 6 subsequently.

Respective embodiments mentioned above has described a function of the semiconductor memory card 1 for automatically judging an interface circuit (IF) employed by the host device. In addition to the function, the semiconductor memory card 1 may additionally include a function for changing an interface circuit (for example, a function for selecting either the first IF circuit or the second IF circuit) based on a setting in accordance with a command and the like from the host device. The semiconductor memory card 1, accordingly, is able to be flexibly applied to various host devices such as a host device applied to only either one interface circuit and a host device applied to both interface circuits. That is to say, since the semiconductor memory card 1 automatically judges the IF when the host device employs only either one interface circuit and operates, the host device is able to input and output data to and from the semiconductor memory card 1 regardless of types of the IF. When the host device includes two IFs, the host device is able to use the semiconductor memory card 1 with changing the two IFs due to convenience of the host device.

The embodiments of the present invention has been described above with referring to the figures, however, the present invention is not limited to the embodiments. The present invention, for example, is able to be applied to a case of employing other transmission systems, and a semiconductor memory card is able to include three transmission systems of the single-end signaling system, the differential signaling system, and the low-amplitude single-end signaling system.

### INDUSTRIAL APPLICABILITY

According to the present invention, the semiconductor memory card employing a plurality of transmission systems is able to change the system by identifying a transmission system employed by the host device. The host device, accordingly, may include only either one of the transmission systems, and the semiconductor memory card is useful as a semiconductor memory card detachable and used in a low-cost memory system.

1-13. (canceled)

14. A semiconductor memory card which is detachable from a host device and which transmits and receives a signal via a plurality of signal lines to and from the host device, comprising:
a first interface (hereinafter referred to as IF) circuit for inputting and outputting a first IF signal;
a second IF circuit for inputting and outputting a second IF signal;
a first command receiving unit for receiving a command inputted to said first IF circuit;
a second command receiving unit for receiving a command inputted to said second IF circuit; and
an IF control unit for judging that said host device employs said first IF circuit when receiving a first command by said first command receiving unit and judging that said host device employs said second IF circuit when receiving a second command by said second command receiving unit.

15. The semiconductor memory card according to claim 14 wherein
said IF control unit judges that said host device includes a IF circuit capable of applying to said first IF circuit when receiving said first and second command signals by said first command receiving unit and said second command receiving unit, respectively.

16. The semiconductor memory card according to claim 14 wherein
said first IF circuit is a single-end signaling IF circuit and said second IF circuit is a differential signaling IF circuit.

17. The semiconductor memory card according to claim 14 wherein
said first IF circuit and said second IF circuit are the single-end signaling IF circuits and voltage levels of an inputted signal are different each other.

18. The semiconductor memory card according to claim 17 wherein
said second IF circuit to which a signal of level lower than that to said first IF circuit is inputted includes a differential signaling circuit for comparing a ground voltage to an inputted signal.

19. The semiconductor memory card according to claim 14 wherein
said IF control unit sets said first IF circuit to be in operation state and sets said second IF circuit to be in suspended state when judging that the host includes said first IF circuit and sets said second IF circuit to be in operation state and sets said first IF circuit to be in suspended state when judging that the host includes said second IF circuit.

20. The semiconductor memory card according to claim 14 wherein
said IF control unit sets said first IF circuit and said second IF circuit to be an input status in turning a power on.

21. The semiconductor memory card according to claim 14 which selects either one of said first IF circuit and said second IF circuit based on setting of said host device.
